(19) United States
(12) Patent Application Publication
(10) Pub. No.: US 2025/0265563 A1
(43) Pub. Date: Aug. 21, 2025

(54) MOBILE PAYMENT AND MONITORING DEVICE FOR GAMING MACHINES

(71) Applicants: John Tarpley, Kansas City, MO (US); Mike Farnet, Kansas City, MO (US)

(72) Inventors: John Tarpley, Kansas City, MO (US); Mike Farnet, Kansas City, MO (US)

(21) Appl. No.: 19/059,079

(22) Filed: Feb. 20, 2025

Related U.S. Application Data
(60) Provisional application No. 63/555,495, filed on Feb. 20, 2024.

(51) Int. Cl. G06Q 20/18; G06Q 10/087; G06Q 20/32; G06Q 20/40

(52) U.S. Cl. CPC G06Q 20/18; G06Q 10/087; G06Q 20/322; G06Q 20/40

(57) ABSTRACT

A cloud-enabled mobile payment and monitoring device for installation into an existing coin, bill, credit card, or token-operated gaming machine accepts mobile electronic payments from payment services such as PayPal and Venmo. Mobile payments actuate the machine without inhibiting the ability of the machine to continue to locally accept coins, bills, credit cards, or tokens. In a preferred embodiment, the device allows offline operation, storing transaction data when no Internet connection is available so that customers can continue to use coin, bill, token, and credit card payment methods and use the machines, with the transactions stored in the device and reported and verified once an Internet connection is re-established. Transactional and inventory information for the machine is recorded for monitoring and review by an owner or operator of the machine.

### CROSS-REFERENCE TO RELATED APPLICATIONS

This application claims the benefit of U.S. Provisional Patent Application No. 63/555,495 filed Feb. 20, 2024, the disclosure of which is hereby incorporated herein in its entirety by reference.

### BACKGROUND

Coin-operated machines, such as arcade games, vending machines, amusement rides, and other types of equipment and machines are widely used in various settings, such as arcades, entertainment centers, shopping malls, airports, and hotels. These machines typically accept coins, bills, or tokens as payment for the immediate use of the machine or the dispensing of a product.

While such machines remain popular with consumers, changes in consumer payment methods and spending habits over the past several years have forced many arcades and businesses having coin, bill, and token-operated machines to reconsider their approach to keeping their fleet of machines operational and relevant. Because consumers are rapidly adopting electronic payment methods-such as credit cards, debit cards, and cell phone accessible payment services such as PayPal and Venmo-many people do not carry any cash or coins. Thus, in order to allow consumers to continue to use and buy from the existing gaming and vending machines, businesses must typically provide some type of exchange service to allow customers to get the coins, bills, or tokens that they need to play the games (or buy the products), such as by installing coin, bill, or token dispensing machines to allow customers to convert their electronic payments to coins, bills, or tokens, or by having employees available to provide exchanges of those payment methods for coins, bills, or tokens-all of which increases the operating and overhead costs of the business.

While new gaming machines having built-in electronic payment options are available, the cost of replacing entire machines is not feasible for most smaller arcades and independent businesses having only a few machines. Similarly, while retrofit credit card accepting devices are available to replace current coin, bill and token-accepting mechanisms, complete replacement with those devices is likewise expensive and cost-prohibitive for many small businesses, especially those with more than one or two machines. And, credit card payment mechanisms-whether in new machines or in retrofit mechanisms-require an active Internet or other network connection to verify the transaction before the gaming machine or vending machine is activated. Thus, in cases where a connection is not available to immediately verify the transaction, for example, an arcade's Internet service is interrupted, its local Wi-Fi network is down, cell service is interrupted, or a dial-up connection fails, transactions are unable to be verified and the consumer is unable to use the machine-thus the business loses customers and revenue.

Furthermore, reconfiguration of machines to accept only electronic payments presents a barrier to consumers who do prefer to use cash and coins. And, because many arcades continue to use older gaming machines because of their wide popularity (e.g., vintage pinball and video games) modifying the machines to exclude the use of coins can diminish the nostalgic (and actual) value of such vintage machines.

Thus, it can be seen that there remains a need in the art for improved systems of allowing existing gaming machines to accept electronic payments while simultaneously allowing those machines to continue to accept coins, bills, and tokens if a consumer chooses to do so.

### SUMMARY

Embodiments of the invention are defined by the claims below, not this summary. A high-level overview of various aspects of the invention is provided here to introduce a selection of concepts that are further described in the detailed description section below. This summary is not intended to identify key features or essential features of the claimed subject matter, nor is it intended to be used in isolation to determine the scope of the claimed subject matter. In brief, this disclosure describes a cloud-enabled mobile payment and monitoring device that can be easily and inexpensively installed into an existing coin, bill, or token-operated machine to accept an electronic payment and actuate the machine without inhibiting the ability of the machine to continue to accept coins, bills, or tokens. In a preferred embodiment, the device allows offline operation, storing transaction data when no Internet connection is available so that customers can continue to use coin, bill, token, and credit card payment methods and use the machines, with the transactions stored in the device and reported and verified once an Internet connection is re-established.

In some embodiments, the device may further provide remote monitoring capability to track activity at the machine, such as tracking financial transactions—e.g., the number and dollar amounts of coin, bills, and tokens accepted by, and dispensed by, the machine—as well as tracking usage times, inventory (in the case of vending, ticket, or prize dispensing machines) and other machine operational parameters.

In one aspect, the device is cloud-connected and enables mobile-based payment and remote monitoring for coin-operated machines, eliminating the need for physical coins, currency, or tokens by allowing users to pay via smartphones, tablets, or other connected devices using credit cards, third-party wallets or payment services such as PayPal, Venmo, and the like.

In another aspect, the device is operable even without an active Internet connection, storing transaction data locally on the device and reporting and verifying those transactions once a connection is available. In a further aspect, the device interfaces with existing coin, bill, token, and credit card mechanisms so that the gaming machine continues to accept those payment methods in addition to electronic payments.

In yet another aspect, the device interfaces with a machine's existing electronic circuitry and simulates the electronic pulses generated by the machine's traditional coin or bill insertion mechanisms by generating electronic pulses in response to a customer's electronic payment. In a preferred embodiment the pulses generated by the device are configurable to allow compatibility with various coin, bill, and token activated devices. In further embodiments, the device may be used to augment or replace a coin slider mechanism, such as commonly found in arcade pool tables, washer/dryer machines, and the like, with the device simulating the electronic pulses generated by the slider mechanism.

In another aspect, the device provides a business owner or machine operator with real-time financial and operational data, generates reports for revenue tracking and machine maintenance, and provides a web-based interface allowing owners and operators to manage machine settings remotely. Thus, owners and operators can track funds collected, items dispensed, and overall machine performance and generate collection reports for cash accountability for each machine being monitored.

### DESCRIPTION OF THE DRAWINGS

Illustrative embodiments of the invention are described in detail below with reference to the attached drawing figures, and wherein:

FIG. 1 is a perspective view of a mobile payment and monitoring device for gaming machines in accordance with an exemplary embodiment of the present invention;

FIG. 2 is an exploded view of the mobile payment and monitoring device of FIG. 1.

FIG. 3 is a block diagram of logic and control circuitry for a mobile payment and monitoring device for gaming machines in accordance with an exemplary embodiment of the present invention.

FIG. 4 is a block diagram of the logic and control circuitry of FIG. 3 in communication with a gaming machine in accordance with an exemplary embodiment of the present invention.

FIG. 5 is a block diagram of an exemplary configuration of a plurality of mobile payment and monitoring devices for gaming machines connected to a corresponding plurality of gaming machines and in communication over a public network in accordance with an exemplary embodiment of the present invention.

FIG. 6 is a flow diagram of activation of a gaming machine via a mobile payment using a mobile payment and monitoring device for gaming machines in accordance with an exemplary embodiment of the present invention.

FIG. 7 is a flow diagram of online and offline monitoring and storing of payment and machine information in a mobile payment and monitoring device for gaming machines in accordance with an exemplary embodiment of the present invention.

FIG. 8 is a flow diagram of remotely accessing a mobile payment and monitoring device for gaming machines to view and retrieve data in accordance with an exemplary embodiment of the present invention.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described. The terms “about” or “approximately” as used herein denote deviations from the exact value in the form of changes or deviations that are insignificant to the function.

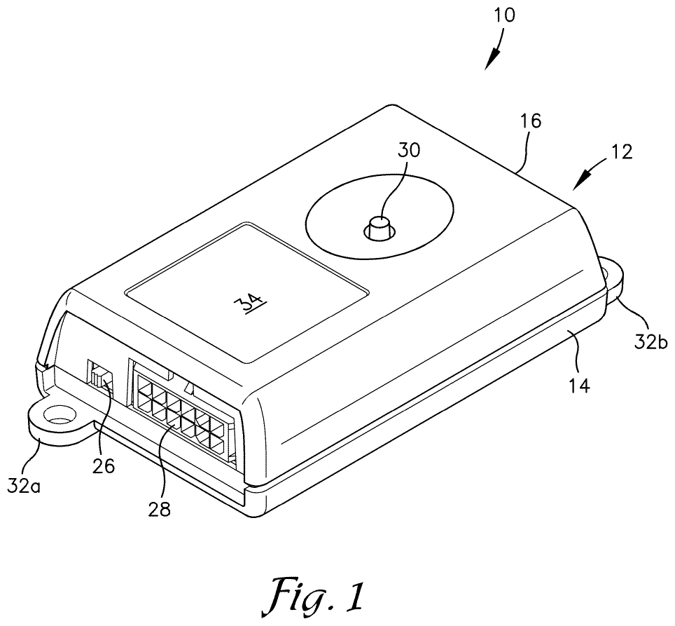

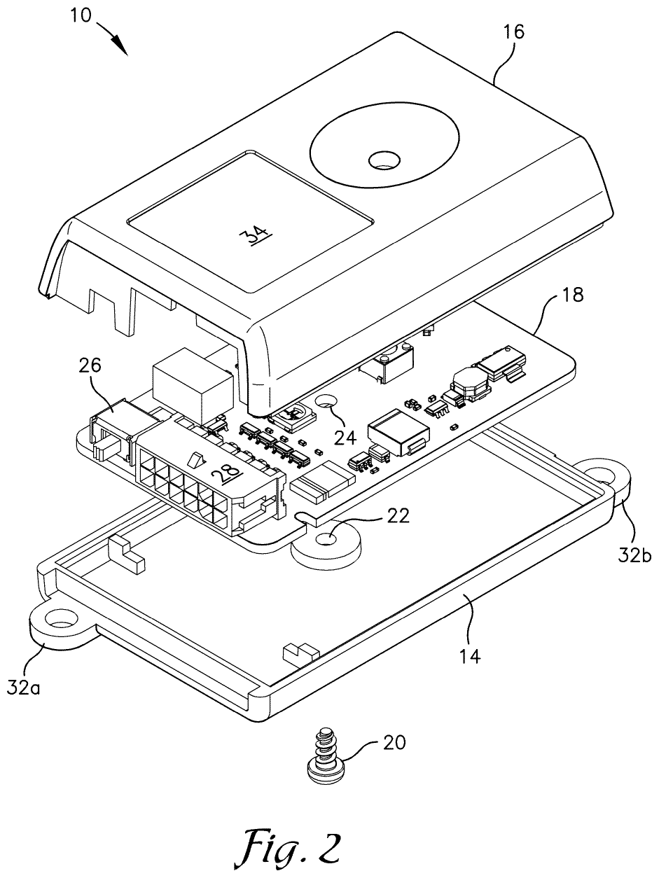

Looking first to FIGS. 1 and 2 in conjunction, a mobile payment and monitoring device for gaming machines in accordance with an exemplary embodiment of the present invention is depicted generally by the numeral 10. The device includes a housing 12, comprised of a lower base 14 and an upper cover 16, with a circuit board 18 positioned and enclosed between the lower base 14 and upper cover 16. The circuit board 18 includes logic and control circuitry thereon (as will be described in more detail below), the logic and control circuitry configured to interface with a gaming machine in which the device is installed and operable to execute various functions and to communicate with the gaming machine as will be described in more detail herein.

It should be understood that while the exemplary embodiments of the device are described herein for use with arcade gaming machines, one skilled in the art will recognize that the device may equally be used with vending machines, amusement rides, coin activated washers and dryers, pool tables, and other machines that use coin, bill, or token mechanisms.

As best seen in FIG. 2, the circuit board 18 is positioned between the lower base 14 and the upper cover 16 and secured therebetween via fastener 20, which extends upwardly through an aperture 22 in the lower base, through an aperture 24 in the circuit board 18, and into a threaded receptacle (not shown in this view) on the underside of the upper cover 16. With the fastener 20 inserted and tightened, the circuit board is secured, sandwiched between the lower base 14 and upper cover 16 to form a compact package suitable for mounting within a gaming machine.

With the circuit board enclosed within the housing 12, a switch 26, a multi-pin input/output socket 28, and an LED 30—all mounted on the circuit board 18 and all part of the logic and control circuitry—are visible and accessible through corresponding cutouts in the upper cover 16.

A pair of mounting tabs 32a, 32b extend outwardly from opposite edges of the lower base 14, with an aperture formed through each tab to allow the device to be secured inside a gaming machine with screws, bolts, or other fasteners. A recessed square receptacle 34 formed in the upper surface of the upper cover 16 provides a surface for attaching a QR code or barcode sticker or emblem which uniquely identifies the device—e.g. by serial number or other unique identifier, preferably encoded in the logic and control circuitry—to allow identification, tracking, and correlation of each installed device with the specific machine it is installed in.

It should be understood that while the exemplary embodiment of the device as just described comprises a removable housing, various other methods of encasing the logic and control circuitry are contemplated by the present invention. For example, the logic and control circuitry may be potted within a housing or case to provide protection to the circuitry and to prevent unauthorized access to, or tampering with, the logic and control circuitry. Likewise, the device may be mounted in a gaming machine using zip ties, adhesive tape, or means other than screws or bolts. These and other variations are within the scope of the present invention.

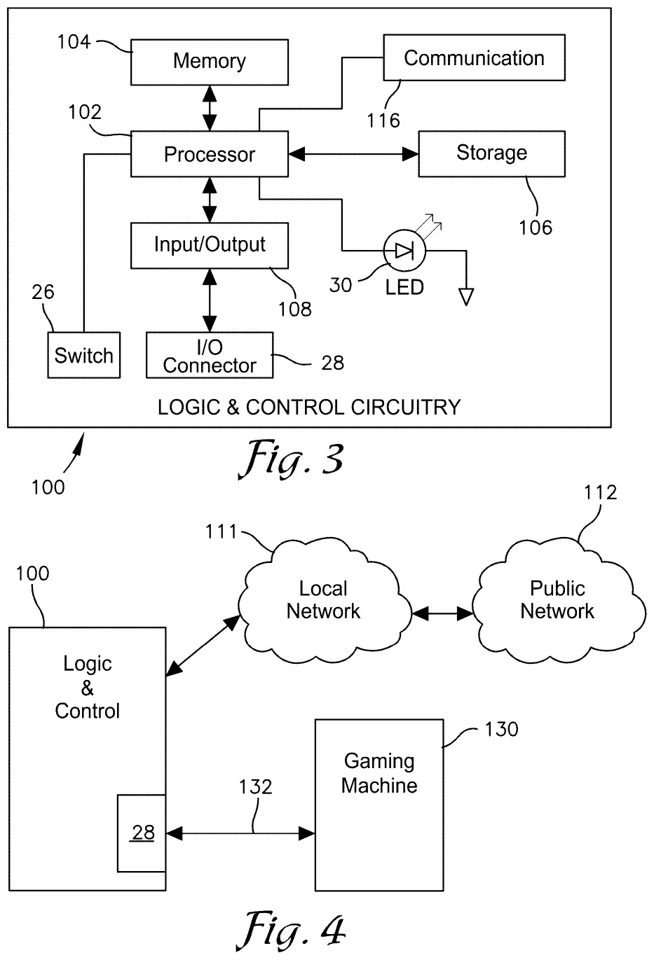

With the physical structure of the mobile payment and monitoring device for gaming machines set forth above, the logic and control circuitry will now be described with reference to FIGS. 3 through 5.

Looking to FIG. 3, a block diagram of the logic and control circuitry of the mobile payment and monitoring device for gaming machines 10 of FIG. 1 is depicted generally as element number 100. The logic and control circuitry includes a processor 102 in communication memory 104, storage 106, input/output circuitry 108, communication circuitry 116, LED 30 (also depicted in FIGS. 1 and 2), and switch 26 (also depicted in FIGS. 1 and 2). The Input/Output circuitry 108 is in further communication with an input/output (I/O) connector 28 (also depicted in FIGS. 1 and 2).

Processor 102 may be any microprocessor, controller, microcontroller or other logic circuitry, or a combination of such devices and circuitry. The processor 102 is operable to execute instructions stored in memory 104 (and/or in storage 106) to perform various commands and operations of the mobile payment and monitoring device for gaming machines. The instructions to be executed by the processor may be stored in memory 104 and/or storage 106 and retrieved by the processor for execution.

Memory 104 may be volatile memory, non-volatile memory, or a combination thereof, with program instructions for the processor 102 preferably stored in non-volatile memory, and volatile memory primarily used for temporary storage of transient data-such as calculation data stored by the processor—and temporary input and output data.

Storage 106 is preferably non-volatile memory for storage of program instructions and storage of data collected from the gaming machine, such as financial transactions (e.g., how many coins, bills, and tokens of various denominations have been received by the gaming machine, and how many electronic payment transactions have occurred, along with data relating to those transactions), operational data (e.g., how long has the gaming machine been powered-up, how many times, and at what time of day has the machine been opened, has the coin or bill box been removed, voltages, currents, and other machine operation parameters), and dispensing and inventory transactions (e.g., what tickets, prizes, products, tokens, etc. have been dispensed, along with the time of day, etc.). The storage 106 may be used for long-term storage of the collected data, which may be deleted once reviewed by an operator, or transferred to, for example, an operator or business owner's computer. In some embodiments, older data stored in the storage 106 may be overwritten with new data in the event the storage 106 reaches capacity.

Input/output circuitry 108 preferably comprises interface circuitry to allow electrical connection and communication between the processor and the gaming machine, via I/O connector 28. The interface circuitry may include analog inputs and outputs, digital inputs and outputs, pulse width modulator outputs, power pins (for powering the logic and control circuitry), and communication inputs and outputs (e.g., transmit TX and receive DX). The interface circuitry may further include isolation and protection circuitry for any of the inputs and outputs as required.

The input/output circuitry 108 preferably connects to the I/O connector 28 through wiring or traces on the circuit board 18, with the connector 28 configured to accept a mating connector of a gaming machine interface cable to allow electrical communication between the gaming machine and the logic and control circuitry.

Power for the logic and control circuitry is preferably provided from the gaming machine that the mobile payment and monitoring device is installed in, through the I/O connector 28. In some embodiments, the logic and control circuitry may include an onboard power supply or energy storage device such as a battery or super-capacitor to provide power in the absence or interruption of power from the gaming machine.

In other embodiments the logic and control circuitry 100 may include circuitry such as transformers or converters to step-up or step-down voltages received from the gaming machine, to limit or scale voltages or currents, or to regulate a received voltage.

Switch 26 is preferably in communication with processor 102, either directly or indirectly (e.g., through input/output circuitry 108), and may be used to control power to the logic and control circuitry, or to activate programming, installation, or other modes of operation.

LED 30 may provide a visual indication of power or other status of the logic and control circuitry. For example, the processor 102 may activate the LED to indicate power on to the device, or may activate the LED to flash sequences of on and off to convey a diagnostic code to the operator or maintainer of the mobile payment and monitoring device. In some embodiments, LED 30 may be a multicolor LED, with different colors illuminated to signify various status or states of the logic and control circuitry.

Communication circuitry 116 preferably includes circuitry enabling wireless communication via Wifi, Bluetooth, or other wireless communications protocols to allow connection of the logic and control circuitry local networks and ultimately to the Internet (or other public network). In some embodiments, the communication circuitry may also include wired communication capability, such as Ethernet.

With the device connected to a gaming machine and with the logic and control circuitry 100 in communication with a WiFi network having Internet access, an operator or owner of the device/gaming machine may locally or remotely access the device to review and/or retrieve information from the device, such as information and data stored in storage 106 relating to mobile payments received (e.g. from users using PayPal, Venmo, etc. to activate the device), local payments received (e.g., credit card payments, and coin, bill, and token payments) and inventory of items remaining in the machine (e.g., prizes, tickets, etc.) as well as items or coins, bills, or tokens dispensed from the machine.

When connected to an active WiFi or Bluetooth connection, the logic and control circuitry 100 allows a user to activate a gaming (or other) machine using an online payment method, such as PayPal, Venmo, or other similar services, with the logic and control circuitry storing transaction information in the on-board storage 106 for later retrieval and/or review by an operator. And, while connected, the logic and control circuitry 100 allows activation of a gaming machine via local payment methods, such as coin, bill, token, or credit card payment devices, and continues to monitor dispensing of tickets, prizes, etc. from the machine and to monitor and record machine parameters.

When an active WiFi or other connection is not available, the logic and control circuitry 100 continues to allow users to activate a gaming (or other) machine using local payment methods, such as coin, bill, token, or credit card payment devices, with financial information stored in storage 106. And, without an active Internet connection, the logic and control circuitry 100 continues to monitor the dispensing of tickets, prizes, etc. from the machine and to monitor and record machine parameters. Once the Internet connection is restored, the stored/queued information may be processed—e.g., data may be transferred, credit card transactions may be processed—and the device is again available for remote monitoring and interaction by the machine owner/operator.

In one preferred embodiment, the logic and control circuitry 100 provides a user interface, such as a web page, through the communication circuitry 116 to allow an owner/operator to easily access the device to review and/or retrieve information.

As can be seen, the mobile payment and monitoring device for gaming machines allows owners and operators of existing gaming, vending, or other coin, bill, and token operated machines to upgrade their machines to accept electronic payments and to track and monitor the machines' payment, inventory, and operating information. The device further allows offline operation, and provides an interface allowing the owner/operator to remotely access the device to monitor the collected and stored information, monitor real-time information, and even troubleshoot the machine the device is connected to.

With the structure and operation of the mobile payment and monitoring device for gaming machines set forth above, the configuration of exemplary systems employing a plurality of such devices, and the exemplary operation of those systems will now be described.

Turning to FIG. 4 a block diagram of the logic and control circuitry 100 of the mobile payment and monitoring device for a gaming machine of the present invention is depicted connected to a gaming machine 130 via a gaming machine interface cable 132, and in communication with a local network 111 that is in further communication with a public network 112, such as the Internet.

As described above, the logic and control circuitry 100 includes WiFi communication circuitry to allow the logic and control circuitry to connect to a local network 111, such as a WiFi router at an arcade. The local network 111 is in further connection with a public network 112, such as the Internet, typically provided to the arcade through an Internet Service Provider. In alternative embodiments, the connection between the logic and control circuitry 100 and the local network may be via a Bluetooth or other wireless communications protocol.

As described above, the input/output circuitry 108 of the logic and control circuitry 100 interfaces to the gaming machine 130 through a gaming machine interface cable 132 plugged into I/O connector 28 of the device. With the gaming machine 130 connected to the device and the logic and control circuitry 100, the device may communicate with the gaming machine 130 and may communicate over the Internet/public network 112 (through local network 111) such that the device may accept electronic payments from a user and activate the gaming machine 130 for the user.

As also described above, the device may monitor, capture, and store gaming machine information, such as payment information and operational parameters of the machine, and allow an owner/operator to locally or remotely connect to the device to review., monitor, or download stored information. Furthermore, in an offline mode (i.e., in the event of failure of the Internet connection), the device may continue to collect local payment information, with stored financial transactions processed once the Internet connection is restored.

Looking to FIG. 5, in one exemplary configuration and use of the present invention, a plurality of mobile payment and monitoring devices for gaming machines 118a, 118b, 118c are connected to a corresponding plurality of gaming machines 120a, 120b, 120c in a manner as described above. Each device 118a, 118b, 118c connects to a public network 112 (e.g., via a WiFi connection to a local network, which in turn connects to the public network). With the plurality of gaming machines connected to the plurality of devices 118a, 118b, 118c, an owner/operator of the arcade may access each device via a personal computer 124 or other smart device to monitor and review the financial and operational information and data stored on each device.

With the structure, configuration, and exemplary connection of the mobile payment and monitoring device for a gaming machine set forth, exemplary operations of the device will now be described.

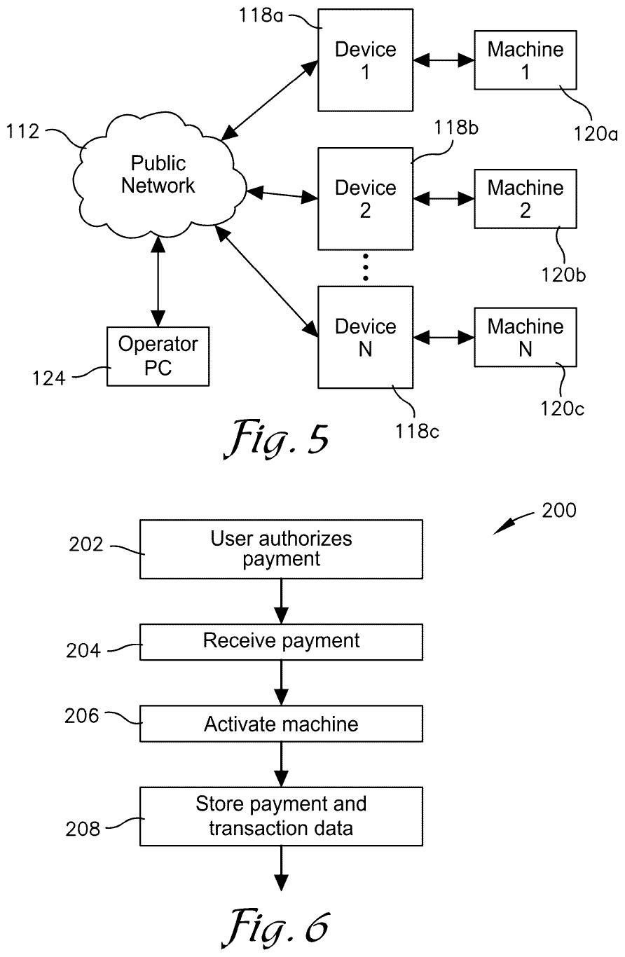

Looking to FIG. 6, a flow diagram of activation of a gaming machine via a mobile payment using a mobile payment and monitoring device for gaming machines in accordance with an exemplary embodiment of the present invention is depicted as 200.

At block 202 a user, using a mobile payment system such as PayPal, Venmo, or the like, authorizes a payment to activate a specific gaming machine. Each mobile payment and monitoring device for gaming machines is preferably assigned a unique identifier number that is presented to user by a sticker, QR code, or other identifier on the gaming machine so that the payment authorized by the user is designated for that specific machine. Depending on the payment system used and the configuration determined by the owner/operator of the machine, the identification of the machine may further include location and other information corresponding to the specific gaming machine.

Once the payment from the user's mobile payment system is authorized, at block 204 the payment is received by the mobile payment and monitoring device via an Internet connection to that device as described above.

At block 206, with payment received, the machine is activated and ready for use by the user. It should be understood that activation and ready for use may be actual activation of the machine for use, or may be a credit applied to the machine so that the user may, for example, play multiple successive games, with each game usage depleting the credit that has been applied-just as if a user had inserted coins, bills, tokens, or used a credit card to apply credits to the machine.

At block 208, the payment transaction and machine activation and operational information is stored in the memory and/or storage of the device, as described above, so that an owner/operator may later review or retrieve that information.

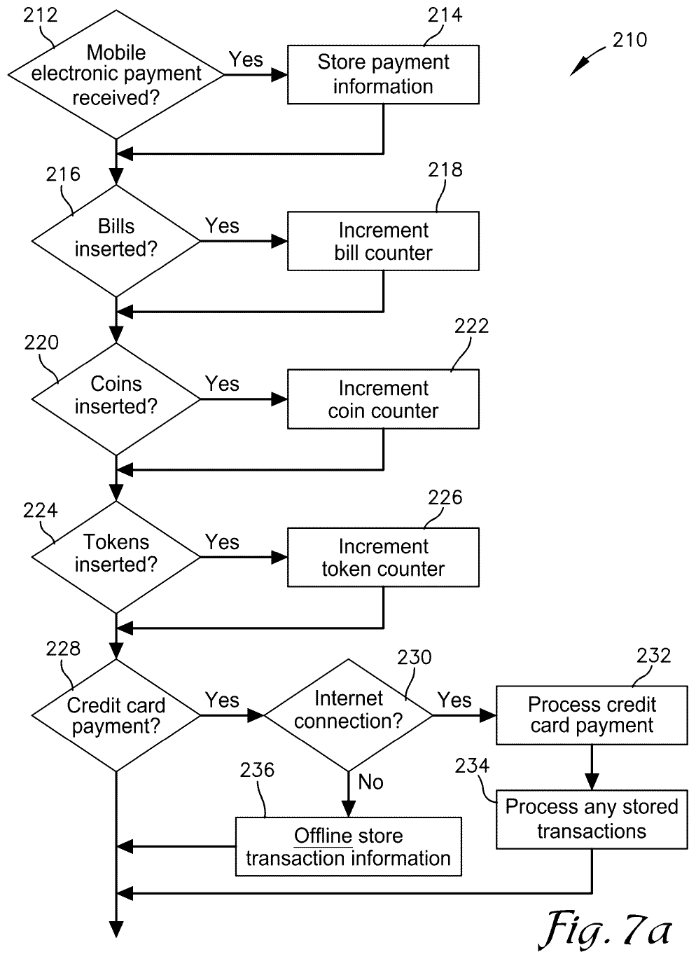

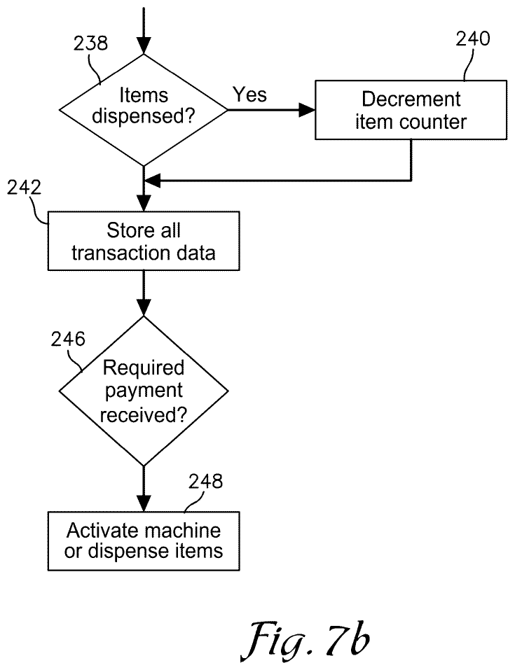

Turning to FIG. 7, online and offline monitoring and storing of payment and machine information in a mobile payment and monitoring device for gaming machines in accordance with an exemplary embodiment of the present invention is shown as 210.

As discussed above, in the event of no active Internet connection, the mobile payment and monitoring device will continue to store machine operational and local payment information, with credit card transaction information stored for processing once the Internet connection is restored.

At block 212, upon receipt of a mobile electronic payment (e.g., as described with respect to FIG. 6), at block 214 the payment and transaction information is stored in the memory or storage of the device.

At block 216, if a currency bill has been inserted and received by the bill mechanism on the machine, at block 218 the receipt of the bill is counted and stored in memory.

At block 220, if a coin is inserted, at block 222 receipt of the coin by the coin mechanism is counted and stored in memory.

At block 224, if a token is inserted, then at block 226 receipt of the token is counted and stored in memory.

As should be apparent, whether online or offline (i.e., whether there is an Internet connection or not) any local payment type—e.g., bills, coins, or tokens—can be accepted by the gaming machine, and the mobile payment and monitoring device will monitor and count those transactions and record machine parameters.

At bock 228, if a user pays using a credit card, and at block 230 if there is an active Internet connection (i.e., online operation), then at block 232, the credit card payment is processed and stored in memory or storage.

At block 230, if there is no active Internet connection (i.e., offline operation), then at block 236 the credit card transaction is stored for processing once the Internet connection is restored.

At block 234, with an active Internet connection, any stored credit card transactions (i.e., any transactions that occurred while the Internet connection was down) are processed for payment.

Thus, as described above, in offline mode, the mobile payment and monitoring device can continue to accept local payments and provide credit for use by a user, with the transactions occurring during the offline time processed once the Internet connection is restored.

Continuing at block 238, as described above, the mobile payment and monitoring device also monitors any items (e.g., tickets, prizes, change, etc.) dispensed from the gaming machine. If any items are dispensed, at block 240 that item's counter is decremented to provide an up-to-date inventory of remaining items.

At block 242, all transaction data for any payment or dispensing from any machine is recorded and stored in the memory or storage of the mobile payment and monitoring device.

At block 246, if a payment has been received via any of the available payment methods then at block 248, the machine is activated—i.e., a credit is applied to the machine and the machine is available for use by a user.

The steps as just described are repeated continuously, with the mobile payment and monitoring device monitoring for any payments (via any local or mobile payment services) as well a monitoring any items dispensed from the machine, with all transactions recorded and stored in the memory or storage of the device. And, as described, any transactions occurring in offline mode (i.e., no Internet connection) are processed once the Internet connection is restored.

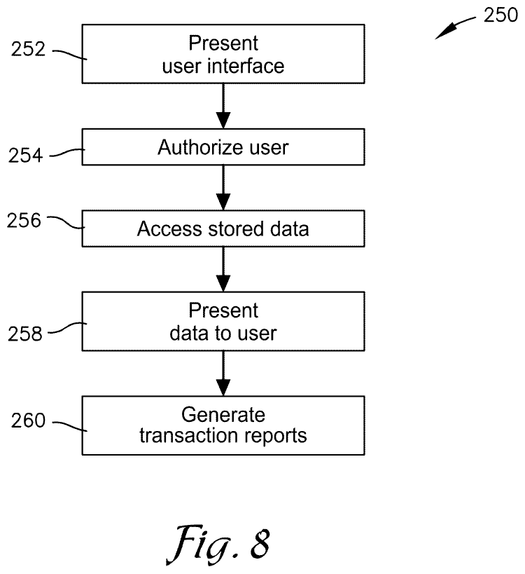

Looking to FIG. 8, a method of remotely viewing and retrieving data from a mobile payment and monitoring device in accordance with an exemplary embodiment of the present invention is depicted as 250.

At block 252, a remote user, such as an owner or operator of a gaming machine having a mobile payment and monitoring device accesses the device and the device presents a user interface, such as a web page

At block 254 the device authorizes the user by a password, PIN code, or other authorization method.

At block 256, in response to queries from the user, the device accesses stored transactional information, such as payment information, and prize, ticket, or product inventory information and at block 258 the information is presented to the owner/operator, allowing them to monitor financial, inventory, and operational data from the gaming machine.

At block 260, transaction reports may be generated and downloaded from the device.

From the above, it can be seen that the mobile payment and monitoring device for gaming machines of the present invention allows users to pay for access to a machine using mobile payment methods such as PayPal, Venmo, and the like, allows operation of the machine in an offline mode in the event of no Internet access, and allows owners and operators of machines to access transactional data of the machine, or of a group of machines.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure and in the claims below is intended to be inclusive of structures and arrangements or designs thereof that are within the scope of this disclosure and readily identifiable by one of skill in the art and that can perform the particular function in a similar way. Certain features and sub-combinations are of utility and may be employed without reference to other features and sub-combinations and are contemplated within the scope of the claims.

What is claimed is:

1. A mobile payment and monitoring device for gaming machines, comprising:
a housing enclosing logic and control circuitry; wherein the logic and control circuitry comprises:
communication circuitry operable to communicate over a wireless network;
input/output circuitry operable to interface with and communicate with a gaming machine in which the mobile payment and monitoring device is installed; and
a processor, a memory device, and a storage device, wherein the memory device has stored thereon executable instructions that, when executed by the processor, cause the mobile payment and monitoring device to perform operations comprising:
receiving, from a third-party mobile payment service, payment authorization transmitted over the Internet;
activating the gaming machine in response to the received payment authorization;
storing information related to the payment authorization and machine activation in the storage device; and
monitoring and periodically storing machine operational data and performance information in the storage.

2. The mobile payment and monitoring device for gaming machines of claim 1, wherein the memory device has further stored thereon executable instructions that, when executed by the processor, cause the mobile payment and monitoring device to perform further operations comprising:
detecting payments received from payment mechanisms installed in the gaming machine, wherein the payment mechanisms comprise currency bill mechanisms, coin mechanisms, token mechanisms, credit card payment mechanisms, or combinations thereof;
counting and categorizing the detected payment types and values; and
storing information related to the detected payments from the payment mechanisms installed in the gaming machine in the storage device.

3. The mobile payment and monitoring device for gaming machines of claim 2, wherein the memory device has further stored thereon executable instructions that, when executed by the processor, cause the mobile payment and monitoring device to perform further operations comprising:
detecting whether an active Internet connection is available via the communication circuitry; and
if an active Internet connection is not detected, storing transaction information received from the credit card payment mechanism in the storage for later processing.

4. The mobile payment and monitoring device for gaming machines of claim 3, wherein the memory device has further stored thereon executable instructions that, when executed by the processor, cause the mobile payment and monitoring device to perform further operations comprising:
upon detection of an active Internet connection, processing stored payment transactions.

5. The mobile payment and monitoring device for gaming machines of claim 1, wherein the memory device has further stored thereon executable instructions that, when executed by the processor, cause the mobile payment and monitoring device to perform further operations comprising:
detecting items dispensed from the gaming machine;
counting and categorizing the items dispenses; and
storing information related to the dispensed items in the storage.

6. The mobile payment and monitoring device for gaming machines of claim 1, wherein the detected items comprise tickets, prizes, products, coins, tokens, or combinations thereof.

7. The mobile payment and monitoring device for gaming machines of claim 1, wherein the memory device has further stored thereon executable instructions that, when executed by the processor, cause the mobile payment and monitoring device to perform further operations comprising:
detecting an attempt to connect to the device over the wireless network;
presenting a user interface to a user attempting to connect to the device;
authorizing the user's credentials and granting access to the device;
retrieving stored transactional and machine operational information to the user in response to user queries.

8. The mobile payment and monitoring device for gaming machines of claim 7, wherein the memory device has further stored thereon executable instructions that, when executed by the processor, cause the mobile payment and monitoring device to perform further operations comprising:
presenting financial and inventory reports in predetermined formats to the user.

9. The mobile payment and monitoring device for gaming machines of claim 1, wherein activating the machine comprises storing a dollar value of credit on the machine; transmitting signals to the machine simulating the signals generated by coin, bill, or token mechanisms; or combinations thereof.

10. The mobile payment and monitoring device for gaming machines of claim 9, wherein the signals simulating the signals of coin, bill or token mechanisms comprises voltage levels, current levels, pulse width signals, or combinations thereof.

11. The mobile payment and monitoring device for gaming machines of claim 1, further comprising a unique device identifier allowing the device to be associated with the gaming machine.

12. The mobile payment and monitoring device for gaming machines of claim 11, wherein the unique device identifier is a QR code, a barcode, or other unique code to allow an owner or operator of the machine to identify and correlate a particular gaming machine to the device.

13. The mobile payment and monitoring device for gaming machines of claim 11, wherein the unique device identifier is used to install and initialize the device for use with a gaming machine.

14. A mobile payment and monitoring device for gaming machines, comprising:
logic and control circuitry comprising:
communication circuitry operable to communicate over a wireless network;
input/output circuitry operable to interface with and communicate with a gaming machine in which the mobile payment and monitoring device is installed; and
a processor, a memory device, and a storage device, wherein the memory device has stored thereon executable instructions that, when executed by the processor, cause the mobile payment and monitoring device to perform operations comprising:
detecting whether an active Internet connection is available via the communication circuitry;
receiving, from a third-party mobile payment service, payment authorization transmitted over the Internet;
activating the gaming machine in response to the received payment authorization;
storing information related to the payment authorization and machine activation in the storage device; and
monitoring and periodically storing machine operational data and performance information in the storage.

15. The mobile payment and monitoring device for gaming machines of claim 1, wherein the memory device has further stored thereon executable instructions that, when executed by the processor, cause the mobile payment and monitoring device to perform further operations comprising:
detecting payments received from payment mechanisms installed in the gaming machine, wherein the payment mechanisms comprise currency bill mechanisms, coin mechanisms, token mechanisms, credit card payment mechanisms, or combinations thereof;
counting and categorizing the detected payment types and values; and
storing information related to the detected payments from the payment mechanisms installed in the gaming machine in the storage device.

16. The mobile payment and monitoring device for gaming machines of claim 15, wherein the memory device has further stored thereon executable instructions that, when executed by the processor, cause the mobile payment and monitoring device to perform further operations comprising:
if an active Internet connection is not detected, storing transaction information received from the credit card payment mechanism in the storage for later processing.

17. The mobile payment and monitoring device for gaming machines of claim 16, wherein the memory device has further stored thereon executable instructions that, when executed by the processor, cause the mobile payment and monitoring device to perform further operations comprising:
upon detection of an active Internet connection, processing stored payment transactions.

18. The mobile payment and monitoring device for gaming machines of claim 15, wherein the memory device has further stored thereon executable instructions that, when executed by the processor, cause the mobile payment and monitoring device to perform further operations comprising:
detecting items dispensed from the gaming machine, wherein the items comprise tickets, prizes, products, coins, tokens, or combinations thereof.

19. The mobile payment and monitoring device for gaming machines of claim 15, wherein the memory device has further stored thereon executable instructions that, when executed by the processor, cause the mobile payment and monitoring device to perform further operations comprising:
presenting a user interface to an authorized user; and
retrieving stored transactional and machine operational information to the user in response to user queries.

20. The mobile payment and monitoring device for gaming machines of claim 19, wherein the memory device has further stored thereon executable instructions that, when executed by the processor, cause the mobile payment and monitoring device to perform further operations comprising:
presenting financial and inventory reports in predetermined formats to the user.
